(19) United States
(12) Patent Application Publication
(10) Pub. No.: US 2005/0253374 A1
(43) Pub. Date: Nov. 17, 2005

(54) Label incorporating security features

(76) Inventors: Gerald Payne, Somerset (GB); Paul Howland, Hampshire (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/521,120

(22) PCT Filed: Jul. 11, 2003
(86) PCT No.: PCT/GB03/02996

§ 371 Date: Jan. 12, 2005

(30) Foreign Application Priority Data
Jul. 12, 2002 (GB) 0216242.8

(51) Int. Cl. B42D 15/00

(52) U.S. Cl. 283/81

(57) ABSTRACT

The invention relates to labels and in particular to a label which can be used for security applications, such as an authentication certificate, means of identification or the like, as proof of the authenticity or origin of an article to which it is adhered. The label (10) comprises a substrate, having first (12) and second opposing surfaces (13) and comprising first (15) and second sections (16), an adhesive applied to the second surface of the first section for adhering the label, in use, to an article. At least one security feature is incorporated in or on at least one of said first and second sections. The security feature is concealed when the second section is adhered in a non-viewing position, and is revealed when the second section is lifted into a viewing position.

The invention relates to labels and in particular to a label which can be used for security applications, such as an authentication certificate, means of identification or the like, as proof of the authenticity or origin of an article to which it is adhered.

Articles such as CD's, CD-ROM's and DVD's, as well as documents of value and means of identification, such as banknotes, passports, identification cards, certificates and the like, are vulnerable to copying or counterfeiting. The increasing popularity of colour photocopiers, electronic scanning and other imaging systems, and the improving technical, quality of colour photocopiers, has led to an increase in the counterfeiting of such documentation and articles. There is, therefore, a need to improve the security features of such items to add additional security features or to enhance the perceptions and resistance of simulation to existing features.

Steps have already been taken to introduce optically variable features into labels which are applied to such articles and documentation to provide an indication of the authenticity of the goods or documents, and to provide a tamper-indicator. Such labels, for example as described in EP-A-0 773 527, cannot be reproduced by a photocopier or an electronic scanner due to the watermark incorporated in the labels. However, there is a demand to introduce labels which include further security features which are still discernible by the naked eye but are “invisible” to, or viewed differently by, a photocopier or scanner, whilst still maintaining the small size of the label. Since the photocopying process typically involves reflecting high energy light on an original document containing the image to be copied, one solution is to incorporate one or more features into the label which have a different perception in reflected and transmitted light. Some examples of such security features include watermarks, embedded security threads, fluorescent pigments and the like.

Unfortunately, for labels containing these security features the ability to inspect the labels in both reflected and transmitted light is necessary to identify the differences. These types of features have therefore not been considered to be suitable for applications where only one side of the label can be viewed in reflected light, e.g. on a label stuck to another article.

A further problem lies in the fact that for many security applications, the security labels must be small, which means that not much space is available for printed information and security features. It is an object of the present invention to overcome or reduce these disadvantages and provide a label, which can be small in size yet provide sufficient room for the necessary branding and/or printed information required by the manufacturer as well as security features which are detectable in transmissive light and/or reflective light such as watermarks, embedded security threads, fluorescent pigments and the like.

According to the present invention there is therefore provided a label comprising a substrate, having first and second opposing surfaces and comprising first and second sections, an adhesive applied to the second surface of the first section for adhering the label, in use, to an article, at least one security feature incorporated in or on at least one of said first and second sections, which security feature is concealed when the second section is adhered in a non-viewing position, and which is revealed when the second section is lifted into a viewing position.

Thus a label comprising the flap feature of the present invention has wide-ranging security applications as it can be checked for authenticity before application and in-situ by viewing in both transmitted and reflected light and, if watermarks or other tactile features are included, also by touch. Labels according to the present invention provide a high degree of security because they cannot be accurately photocopied, due to the use of both sides of the label, even if the label is removed from the article to which it is attached.

The adhesive which attaches the label to a document or article may be repositionable, or permanent so that attempts to remove the label result in damage to the label. Suitable adhesives include a water activated gum, a self-adhesive coating with a protective silicone backing, a double-sided tape or sheet. The adhesive itself may be ultra violet curable, pressure sensitive, hot melt, permanent or a repositionable adhesive.

The constituents of the base layer may be natural, synthetic or a combination of natural and synthetic.

A preferred embodiment of the present invention will now be described in detail, by way of example only, with reference to the accompanying drawings in which:

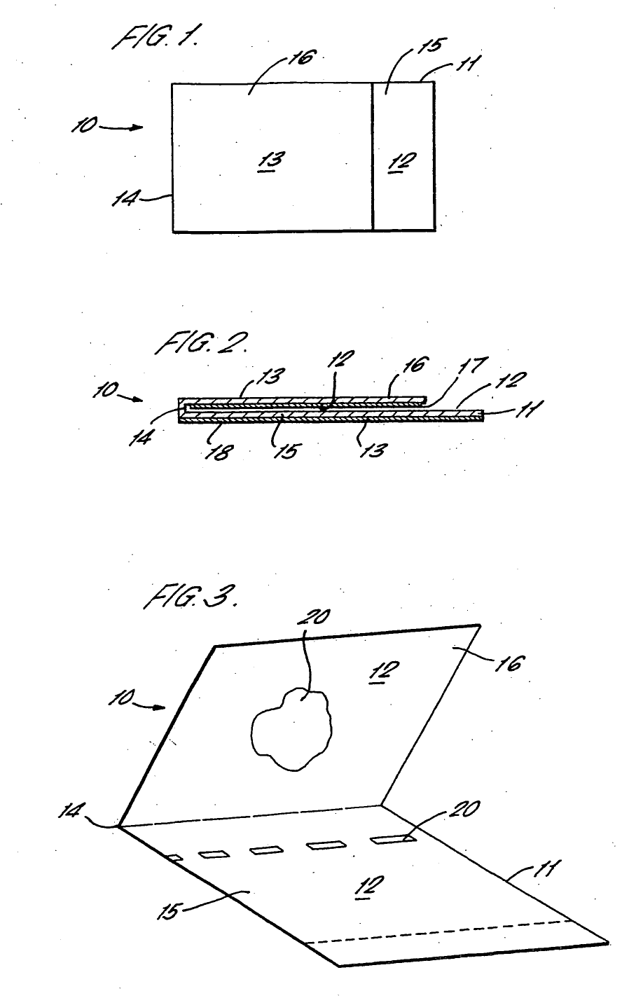

FIG. 1 shows a plan view of a label according to a first embodiment of the present invention.

FIG. 2 shows a side cross sectional elevation of the label shown in FIG. 1, on a vertically exaggerated scale;

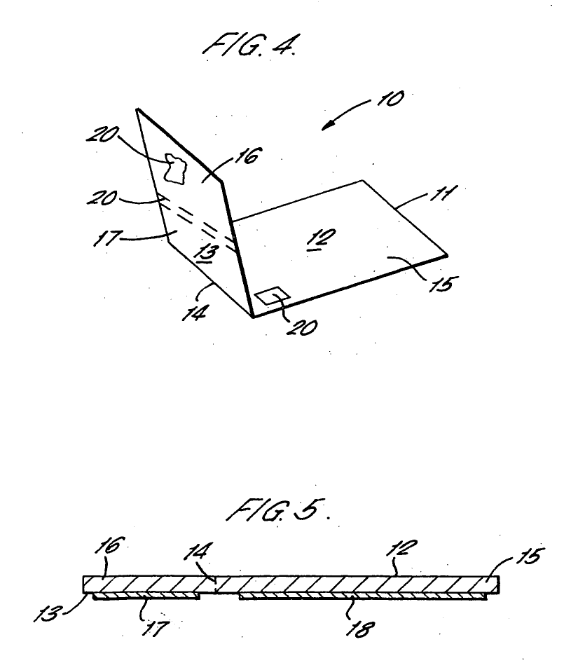

FIG. 3 shows a perspective view of the label of FIG. 1, in a viewing position;

FIG. 4 shows a perspective view of a label according to a second embodiment of the present invention, in a viewing position;

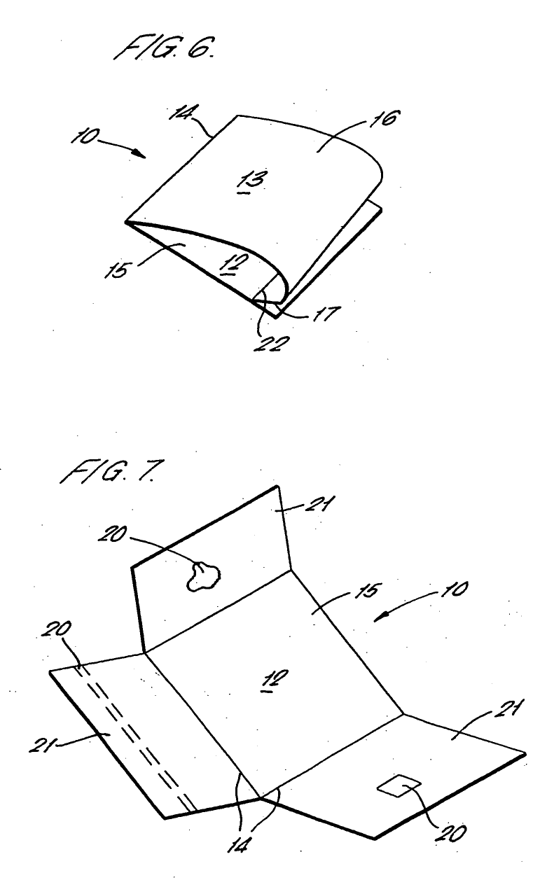

FIG. 5 shows a side cross-sectional elevation of the label of FIG. 4 in a non-viewing position;

FIG. 6 shows a label according to a third embodiment of the present invention, in a non-viewing position; and

FIG. 7 shows a label according to a fourth embodiment of the present invention, in a viewing position.

A label 10 is formed from a layer 11 of a substrate, such as paper or plastic, which layer 11 has a first surface 12 and a second opposing surface 13. The label 10 comprises a first section 15 and a second section 16 which are joined along a fold line 14. An adhesive 18 is applied to the second surface 13 of the first section 15, to enable the label 10 to be attached to an article or document.

The adhesive 18 can be any suitable adhesive applied in a variety of forms, including a water activated gum, a self-adhesive coating with a protective silicone backing, a double-sided tape or sheet. The adhesive 18 itself may be ultra violet curable, pressure sensitive, permanent or a repositionable adhesive. The nature of the adhesive composition dictates the thickness of the layer of adhesive 18.

A second adhesive 17 is also applied to either the first surface 12 of the second section 16 or a portion of the first surface 12 of the first section 15, to allow the second section 16 to be adhered to, the first section 15. The adhesive 17 on the first surface 12 of the second section 16 is any suitable repositionable adhesive, such as one of the “Dry Peel” adhesives available from Beardow Adams (RTM).

In a non-viewing position the first and second label sections 15, 16 are folded along fold line 14 and adhered to each other. The adhesive layer 18 secures the closed label to an article or document with the second surface 13 of the second (flap) section 16 facing upwards.

The label 10 is also provided with one or more security features 20 which are detectable in transmissive light and/or reflective light such as watermarks, embedded or windowed security threads, fluorescent pigments and the like. Two such features are illustrated in FIG. 3, one being a watermark image and the other a windowed security thread.

The security features may be located on the first surface 12 of the first section 15, in the region obscured by the second section 16 when it is folded over, if it is not necessary to view the security feature in transmissive light. If a security feature is to be viewed in transmissive light it is located within, or on either of surfaces 12, 13 of the second section 16. Non-transmissive features can also be located on the first and/or second surface 12 of the second section 16. These features will be concealed when the second section 16 is in its non-viewing position. However, when the label 10 is opened, by peeling the second section.16 away from the first section 15 and lifting it, the concealed features will be revealed and the second section 16 can be held in a position whereby it can be viewed in transmissive light, to examine any transmissive security features therein.

The layer of substrate, 11 may be of paper made using known papermaking machines, such as a cylinder mould or Fourdrinier machines, or it may even be hand-made. A range of fibre types can be used in the making of such paper including synthetic or natural fibres or a mixture of both.

Plastic, substrates can be cast or extruded, as known in the prior art for similar applications.

The security features 20 are created in a known manner, for example as disclosed in EP-A-0059 056 (window threads), EP-A-0650 413 (liquid crystal watermarks), U.S. Pat. No. 5,465,301 (thermochromic thread) or GB 2323 814 (demetallised threads).

A whole variety of security features may be included in the label 10 according to the present invention to enhance the security of the label 10. For example, a wide range of different types of security thread can be used, including holographic threads, demetallised threads, demetallised holographic threads, fluorescent threads, thermochromic threads, coloured/metallised threads, threads with a chip or other machine-readable element, print see through features, machine-readable threads, optically variable threads and microprinted threads. The threads may be wholly embedded or windowed threads, or may be embedded in a manner such that a continuous length of the thread is revealed in one surface of the substrate 11.

Other surface features may also be included such as planchette bands, fibre bands, iridescent coatings and transparentising coatings and print.

Labels 10 according to the present invention are also compatible with many known forms of printing such as intaglio, flexo-gravure, ink jet, hot foil stamping and so on. The labels 10 may also have a glossy or other finish which is clear or translucent.

Advantageously, the labels 10 may bear a brand name, image or printed information on the second surface 13 of the second section 16 which can clearly be seen when the second section 16 is adhered to the first section.15 in its non-viewing position, as shown in FIGS. 1 and 2. When in the viewing position, as shown in FIG. 3, the security features can be viewed in reflective and/or transmissive light as required.

In the embodiment shown in FIGS. 1 to 3, the first and second sections 15, 16 are both rectangular in shape, although the first section 15 is larger than the second section 16. However, the first and second sections 15, 16 could also be of any shape and could both be the same size.

A second embodiment of the label 10, which comprises first and second sections 15, 16, is shown in FIG. 4. In this embodiment the repositionable adhesive layer 17 is on the second surface 13 of the second section 16, which means that in a non-viewing position the sections 15, 16 are not folded about fold line 14, but lie contiguously in the same plane, as shown in FIG. 5.

In a third embodiment of the present invention, as shown in FIG. 6, the repositionable adhesive 17 is applied to the second surface 13 of the second section 16. In order to attach the second section 16 to the first section 15, an edge 22 of the second section 16 is curved towards the fold 14 such that the second surface 13 of the second section 16 is in contact with the first surface 12 of the first-section 15.

The label 10 may also be provided with a plurality of liftable sections 21, in accordance with a fourth embodiment of the present invention, as shown in FIG. 7. In this embodiment, three liftable sections 21 are provided which each hinge about the first section 15 about a fold line 14. In this embodiment, a different security feature 20 may be provided in each liftable section 21, although equally the same security feature 20 could be used for each liftable section 21. Alternatively more than one security feature 20 could appear on one or more of the liftable sections 21. This embodiment is particularly advantageous for applications which require the label 10 to carry a large amount of branding, graphics or other information without the need for a label 10 which is as big as the article to which it is applied.

It is envisaged that the thickness of the substrate layer 11 for making a label 10 according to the present invention will be in the range of 50-130 μm, more preferably 80-100 μm, although this range is not limiting. The substrate from which the label 10 is made does not need to be particularly thick, and, can be less strong than the paper used for banknotes or other similar security documentation which must be hard wearing and resilient due to their continuous handling.

For a label, however, this is not a disadvantage as the label 10 is supported by its backing, before application, or by the article or document to which it is adhered, after application. Furthermore, in any attempted removal of such a label 10 from the article to which it is adhered, as light weakness in the paper layer 11 is likely to lead to tearing, thus providing a tamper-proof feature. However, the layer 11 must be strong enough that lifting the second section 16, particularly against the pulling force of the adhesive layer 17, does not result in tearing.

In one specific example of the present invention, the preferred grammage of a paper substrate used as layer 11 is 50-120 gsm, more preferably 70-90 gsm, although this range is not limiting.

In a further embodiment of the invention the label 10 has a backing paper which is used to protect the label before it is applied to an article or document. A clear or highly translucent backing may be used to enable any security feature 20 incorporated in the first section 15 of the label 10 to be checked in transmitted as well as reflected light before the backing is removed and before application of the label. However, a non-translucent backing may also be used, which requires the removal of the backing before the label 10 can be checked prior to application.

The substrate layer 11 of the label 10 may be a single or two-ply layer. Two-ply paper, for example), is generally made using two separate vats of papermaking furnish which produce two substrates which are compressed together to form a finished paper.

A two-ply label can also be made according to the present invention in which one-ply is of paper and the other is of plastic, such as a clear or a coloured film.

The second section 16 of the label 10 may be removable from the first section 15 of the label 10, according to a further embodiment of the present invention. The fold line 14 may be perforated to ease separation of the first and second sections 15, 16 or a pull tab along the fold line 14 may be incorporated in the label 10 to separate the two sections.

The labels 10 according to the present invention may have a wide range of uses especially as certificates of origin or authentication, and in particular in fields where counterfeiting of the products to which the labels 10 are attached is or may be rife, such as high value added or fast moving consumer goods, for example CD's and DVD's.

Although several specific embodiments of the present invention have been described above, the features described may be used in any combination.

1. A label comprising:
a substrate having first and second opposing surfaces and comprising first and second sections;
an adhesive applied to the second surface of the first section for adhering the label, in use, to an article;
at least one security feature incorporated in or on at least one of said first and second sections, which security feature is concealed when the second section is adhered in a non-viewing position and which is revealed when the second section is lifted into a viewing position.

2. A label as claimed in claim 1, wherein at least one security feature is incorporated in or on the second section and is visible in transmissive light when the second section is lifted into a viewing position.

3. A label as claimed in claim 1, wherein at least one security feature is incorporated in or on the second section and is visible in reflected light.

4. A label as claimed in claim 1, wherein at least one security feature is located on the first and/or second surfaces of the second section.

5. A label as claimed in claim 1, wherein at least one security feature is located on the second surface of the first section.

6. A label as claimed in claim 1, wherein the first and second sections hinge about a fold line.

7. A label as claimed in claim 1, further comprising a second repositionable adhesive applied to at least a part of one surface of the second section.

8. A label as claimed in claim 7, wherein the repositionable adhesive is applied to the first surface of the second section such that it adheres to the first section in the non-viewing position.

9. A label as claimed in claim 7 when dependent on claim 1, wherein the repositionable adhesive is applied to the second surface of the second section such that it can be adhered in use to an article.

10. A label as claimed in claim 1, wherein at least one security feature is an elongated security element.

11. A label as claimed in claim 10, wherein the security element is partially or wholly embedded within the substrate.

12. A label as claimed in claim 1h, wherein the substrate comprises a plurality of second sections, each of which is liftable from a non-viewing position to a viewing position.

13. A label as claimed in claim 1, wherein the second section of the label is separable from the first section of the label.

14. A label as claimed in claim 13, wherein separation of the first and second sections occurs at the fold line by means of perforations along the fold line.

15. (canceled)
